(19) United States
(12) Patent Application Publication
(10) Pub. No.: US 2020/0201519 A1
(43) Pub. Date: Jun. 25, 2020

(54) INFORMATION PROCESSING APPARATUS

(71) Applicant: SHARP KABUSHIKI KAISHA, Sakai City (JP)

(72) Inventor: YOSHIAKI OGISAWA, Sakai City (JP)

(21) Appl. No.: 16/714,124

(22) Filed: Dec. 13, 2019

(30) Foreign Application Priority Data
Dec. 20, 2018 (JP) 2018-238193

(51) Int. Cl. G06F 3/0484; G06F 3/0488; G06F 3/0354

(52) U.S. Cl. CPC G06F 3/04842; G06F 3/04845; G06F 3/03545; G06F 3/04886; G06F 3/04847

(57) ABSTRACT

An information processing apparatus includes a display, an object manager, and an object controller. The display displays an object. The object manager manages the owner attribute of the object. The object controller controls the display priority of the object on the display on the basis of the owner attribute of the object.

### BACKGROUND OF THE INVENTION

### Field of the Invention

The present invention relates to an information processing apparatus.

### Description of the Background Art

An information processing apparatus described in Japanese Unexamined Patent Application Publications No. 2009-163509 control overlapping display of windows in accordance with the priority level between applications. An application window having higher priority is displayed in the front layer and at least a portion of an application window having lower priority is hidden.

There is a known information processing apparatus including a display device having a large screen. An example of such an information processing apparatus is as a touch-screen display table. In the case where a plurality of users share a display device, the users may instruct objects to be displayed on the screen and carry out tasks using the displayed objects. The term “object” refers to display information such as an image, a document, a window, or an icon.

The users of the touch-screen display table are able to place objects on the screen as if the objects are actual documents. Such objects displayed on the screen can be moved or distributed to other users through touch operation. The use of such a touch-screen display table enables a plurality of users to hold a conference.

For example, a display control apparatus described in Japanese Unexamined Patent Application Publications 2008-269044 includes a large display touch panel provided with a user-position sensor. The user-position sensor recognizes the number of users and their positions. On the basis of the number of uses and their position, the display area of the large display touch panel is divided into a plurality of display sub-regions. The display sub-regions are displayed in correspondence with the positions of the users. JP 2008-269044 A discloses a technique of dragging a file displayed in the display sub-area corresponding to the facilitator and thereby causing a document data file that is the same as the file displayed in the display sub-area of the facilitator to appear in the display sub-areas of other participants.

In the case where a display apparatus is used by a plurality of users, the users often want to be provided with regions of the display apparatus having regions that are large enough for displaying and editing their objects. The use of such regions may be disturbed by objects of other users or distributed by other users crossing into their regions.

An object of the present invention, which has been conceived in view of the above-described issues, is to provide an information processing apparatus that is capable of reducing the possibility of a displayed object of a user being disturbed by an object of another user.

### SUMMARY OF THE INVENTION

An information processing apparatus according to the present invention includes a display, a first manager, and a display controller. The display displays an object. The first manager manages an owner attribute of the object. The display controller controls a display priority of the object on the display on the basis of the owner attribute of the object.

According to the present invention, it is possible to prevent displaying of an object owned by a user from being interfered by an object owned by another owner.

### BRIEF DESCRIPTION OF THE DRAWINGS

FIG. 1 is a perspective view of an example of an information processing apparatus according to an embodiment of the present invention.

FIG. 2 is a plan view of an information processing apparatus.

FIG. 3 is a block diagram illustrating an information processing apparatus.

FIG. 4 illustrates an example of an object management table.

FIG. 5 illustrates an example of a region management table.

FIG. 6 illustrates an example of a pen management table.

FIG. 7 is a flowchart illustrating an example of an object management operation of a control device.

FIG. 8 is a flowchart illustrating an example of a region management operation of a control device.

FIG. 9 is a flowchart illustrating an example of an object control operation of a control device.

FIG. 10 illustrates an example display on a display device.

FIG. 11 illustrates another example display on the display device.

FIG. 12 illustrates another example display on the display device.

### DESCRIPTION OF THE PREFERRED EMBODIMENTS

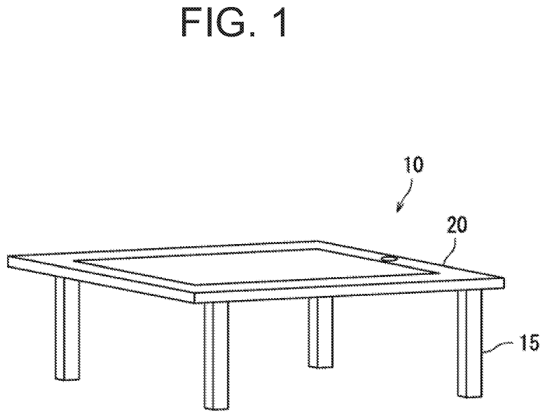

Embodiments of the present invention will now be described with reference to FIGS. 1 to 12. In the drawings, the same or equivalent components are denoted by the same reference numerals, and the descriptions thereof will not be repeated.

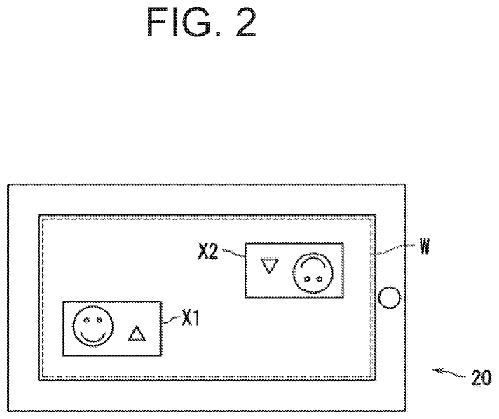

The exterior of an information processing apparatus 10 according to an embodiment will now be described with reference to FIGS. 1 and 2. FIG. 1 is a perspective view of an example of the information processing apparatus 10. FIG. 2 is a plan view of the information processing apparatus 10. The information processing apparatus 10 is a touch-screen display table.

As illustrated in FIG. 1, the information processing apparatus 10 includes legs 15 and a display device 20. The display device 20 corresponds to a table top. The legs 15 support the display device 20.

As illustrated in FIG. 2, the display device 20 has a work area W. The work area W is a region in which users work with a image. For example, a first object X1 and a second object X2 are displayed in the work area W.

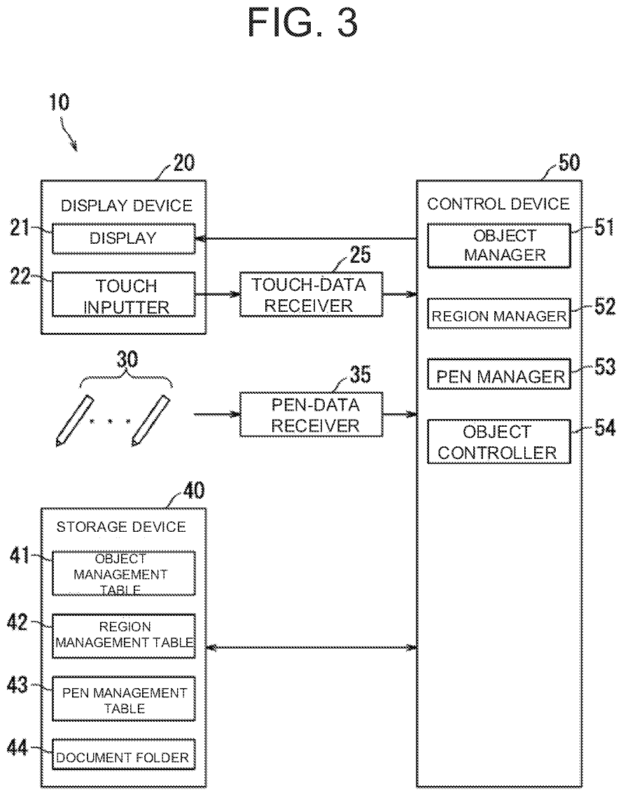

The functional block configuration of the information processing apparatus 10 will now be described with reference to FIG. 3. FIG. 3 is a block diagram illustrating the information processing apparatus 10.

As illustrated in FIG. 3, the information processing apparatus 10 includes, in addition to the display device 20, a touch-data receiver 25, a plurality of touch pens 30, a pen-data receiver 35, a storage device 40, and a control device 50.

The display device 20 includes a display 21 and a touch inputter 22. The display 21 is, for example, a liquid crystal panel that displays objects. The touch inputter 22 is, for example, a touch panel.

The touch-data receiver 25 receives touch data from the touch inputter 22. The touch data includes data indicating the touched position of the touch inputter 22.

The touch pens 30 are tools for performing touch operations on the touch inputter 22. Different pen IDs are assigned to the touch pens 30, respectively.

The pen-data receiver 35 receives pen data from the touch pens 30 via near-field communication during a touch operation. The pen data contains the pen IDs of the touch pens 30.

The storage device 40 includes a storage for storing data and computer programs. The storage device 40 includes a main storage, such as a semiconductor memory, and an auxiliary storage, such as a hard disk drive.

The storage device 40 includes an object management table 41, a region management table 42, a pen management table 43, and a document folder 44. The object management table 41 stores the relations between the objects displayed on the display 21 and the object owners. The region management table 42 stores the relations between regions constituting portions of the display 21 and region owners. The pen management table 43 stores the relations between the pen IDs of the touch pens 30 and the pen owners. The document folder 44 stores document files. For example, display information or a document object is generated from the document file.

The control device 50 includes a processor, such as a central processing unit (CPU). The processor of the control device 50 executes the computer programs stored in the storage device 40 to control each component of the information processing apparatus 10.

A user is able to specify an operation to an object by touch operation the object with a finger or palm. For example, it is possible to specify operations such as moving, scaling, and rotating of an object, and drawing on the objects. A user is also able to specify the various operations described below through touch operation using a touch pen 30.

The control device 50 detects the position of the touch operation on the basis of the touch data received via the touch-data receiver 25. The control device 50 also detects the touch pen 30 that has been used for the touch operation on the basis of the pen data received via the pen-data receiver 35.

The control device 50 includes an object manager 51, a region manager 52, a pen manager 53, and an object controller 54. The control device 50 executes the computer programs stored in the storage device 40, to function as the object manager 51, the region manager 52, the pen manager 53, and the object controller 54.

The object manager 51 creates and updates the object management table 41, to manage the owner attribute of an object displayed on the display 21. The object manager 51 corresponds to an example of a “first manager”.

The region manager 52 creates and updates the region management table 42, to manage the owner attribute of a region constituting the display 21. The region manager 52 corresponds to an example of a “second manager”.

The pen manager 53 creates and updates the pen management table 43, to manage the owner attribute of a touch pen 30. The pen manager 53 corresponds to an example of a “third manager”.

The control device 50 executes a user registration routine (not illustrated). One or more users who wish to share the display device 20 registers their names in an execution menu for the user registration routine. The control device 50 recognizes the names and number of participating users. In the initial state, the work area W is divided into areas equal to the number of participating users, for example. The users further register the pen IDs of the touch pens 30 to be used. As a result, the pen management table 43 is created.

The object controller 54 opens a specified document file in the document folder 44. The object controller 54 then controls the display 21 so as to display, on the display 21, an object associated with to the specified document file. The object controller 54 controls the object display priorities of the objects displayed on the display 21 on the basis of the owner attributes of the objects. In specific, the object controller 54 controls the object display priority of a region on the basis of the owner attribute of the object and the owner attribute of the region. The object controller 54 corresponds to an example of a “display controller”.

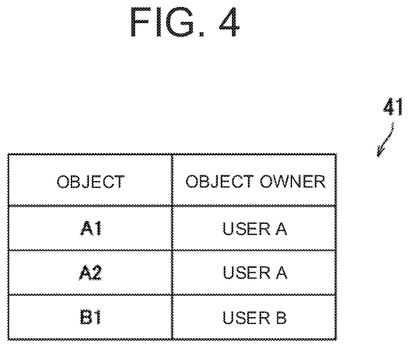

The object management table 41 will now be described with reference to FIGS. 3 and 4. FIG. 4 illustrates an example of the object management table 41.

The object management table 41 stores the relations between the objects displayed on the display 21 and object owners. For example, the object management table 41 stores information indicating that the owner of objects A1 and A2 is user A and the owner of object B1 is user B.

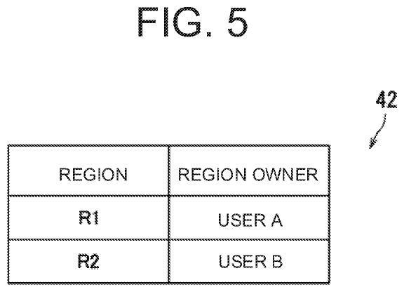

The region management table 42 will now be described with reference to FIGS. 3 and 5. FIG. 5 illustrates an example of a region management table 42.

The region management table 42 stores the relations between regions constituting portions of the display 21 and region owners. For example, the region management table 42 stores information indicating that the owner of a region R1 is user A and the owner of a region R2 is user B.

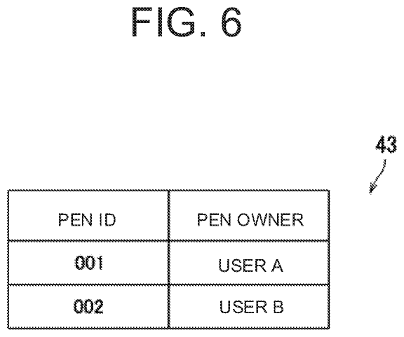

The pen management table 43 will now be described with reference to FIGS. 3 and 6. FIG. 6 illustrates an example of a pen management table 43.

The pen management table 43 stores the relations between the pen IDs of the touch pens 30 and the pen owners. For example, the pen management table 43 stores information indicating that the owner of a touch pen 30 having a pen ID of “001” is user A and the owner of a touch pen 30 having a pen ID of “002” is user B.

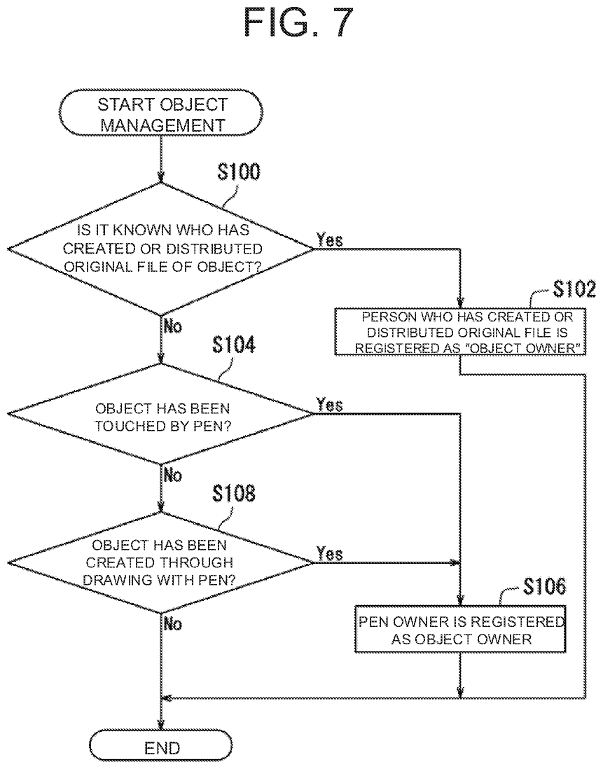

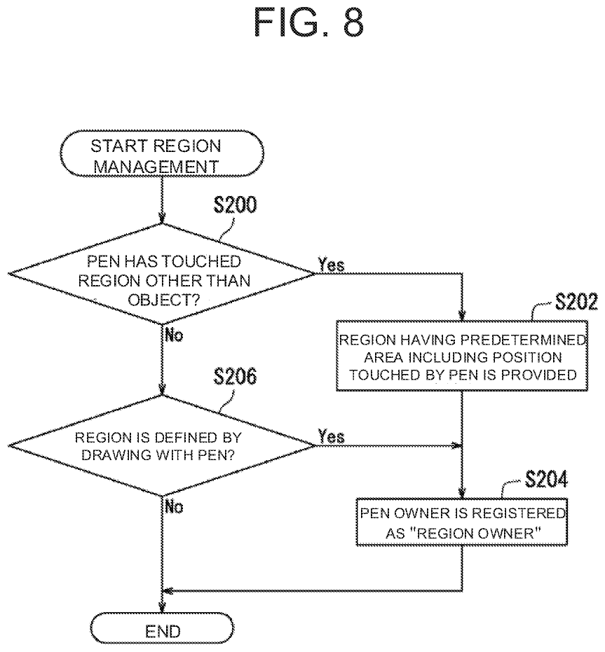

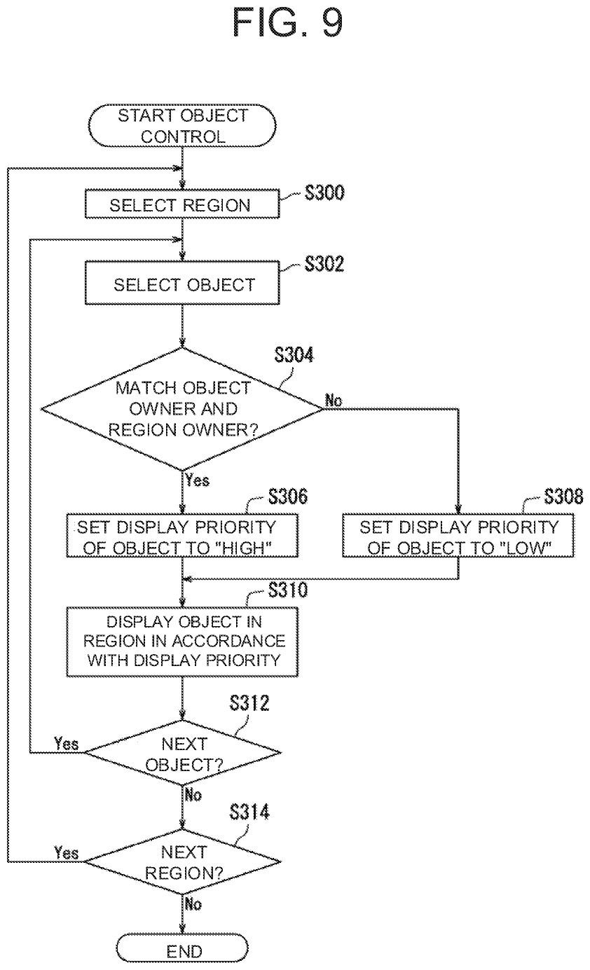

The operation of the control device 50 will now be described with reference to FIGS. 3 to 9. FIG. 7 is a flowchart illustrating an example of an object management operation of the control device 50. FIG. 8 is a flowchart illustrating an example of a region management operation of the control device 50. FIG. 9 is a flowchart illustrating an example of an object control operation of the control device 50. The control device 50 repeats a set of operations. The set of operations consist of the object management operation, the region management operation, and the object control operation.

Step S100: The control device 50 determines whether the user who created or distributed the original file of the object is known, as illustrated in FIG. 7. If it is known who created or distributed the original file of the object (YES in step S100), the process performed by the control device 50 proceeds to step S102. If it is unknown who created or distributed the original file of the object (NO in step S100), the process performed by the control device 50 proceeds to step S104.

Step S102: The control device 50 registers the user who created or distributed the original file of the object as an object owner in the object management table 41. When step S102 is completed, the object management operation of the control device 50 ends.

Step S104: The control device 50 determines whether a touch operation on an object has been performed by a touch pen 30. If a touch operation on an object has been performed by a touch pen 30 (YES in step S104), the process performed by the control device 50 proceeds to step S106. If no touch operation on an object has been performed by a touch pen 30 (NO in step S104), the process performed by the control device 50 proceeds to step S108.

Step S106: The control device 50 registers the owner of the touch pen 30 as an object owner in the object management table 41. When step S106 is completed, the object management operation by the control device 50 ends.

Step S108: The control device 50 determines whether an object has been drawn with a touch pen 30. If an object has been drawn with a touch pen 30 (YES in step S108), the process performed by the control device 50 proceeds to step S106. If no object has been drawn with a touch pen 30 (NO in step S108), the object management operation of the control device 50 ends.

In steps S100 and S102 of the process, the control device 50 initializes the owner attribute of an object so as to register the user who created or distributed the original file of the object to be the object owner. In steps S104 and S106 of the process, the control device 50 changes the owner attribute of an object so that the object has the same owner attribute as the owner attribute of the touch pen 30 used to touch the object. In steps S108 and S106 of the process, the control device 50 sets the object to have an owner attribute indicating the user who created the object.

Step S200: The control device 50 determines whether a touch operation by a touch pen 30 has been performed outside of the object, as illustrated in FIG. 8. If a touch operation by a touch pen 30 has been performed outside of the object (YES in step S200), the process performed by the control device 50 proceeds to step S202. If no touch operation by a touch pen 30 has been performed outside of the object (NO in step S200), the process performed by the control device 50 proceeds to step S206. The touch operation in such a case is a touching up operation without movement of the touch pen 30 touching.

Step S202: The control device 50 provides a region having a predetermined size and containing the position touched by the touch pen 30. When step S202 is completed, the process performed by the control device 50 proceeds to step S204.

Step S204: The control device 50 registers the owner of the touch pen 30 as the region owner in the region management table 42. When step S204 is completed, the region management operation of the control device 50 ends.

Step S206: The control device 50 determines whether a region has been defined through drawing with a touch pen 30. If a region is defined by drawing with a touch pen 30 (YES in step S206), the process performed by the control device 50 proceeds to step S204. If no region has been defined by drawing with a touch pen 30 (NO in step S206), the region management operation of the control device 50 ends.

In steps S200, S202, and S204, the control device 50 sets an owner attribute that is the same as the owner attribute of the touch pen 30 to the region having a predetermined size and containing the position of the display 21 touched by the touch pen 30. In steps S206 and S204, the control device 50 sets an owner attribute that is the same as the owner attribute of the touch pen 30 to the region defined by the touch pen 30 on the display 21.

Step S300: The control device 50 selects one region, as illustrated in FIG. 9. When step S300 is completed, the process performed by the control device 50 proceeds to step S302.

Step S302: The control device 50 selects one object. When step S302 is completed, the process performed by the control device 50 proceeds to step S304.

Step S304: The control device 50 determines whether the owner of the object selected in step S302 matches the owner of the region selected in step S300. If the object owner matches the region owner (YES in step S304), the process performed by the control device 50 proceeds to step S306. If the object owner does not match the region owner (NO in step S304), the process performed by the control device 50 proceeds to step S308.

Step S306: The control device 50 sets the display priority of the object selected in step S302 to be “high”. When step S306 is completed, the process performed by the control device 50 proceeds to step S310.

Step S308: The control device 50 sets the display priority of the object selected in step S302 to be “low”. When step S308 is completed, the process performed by the control device 50 proceeds to step S310.

Step S310: The control device 50 displays the object selected in step S302 in the region selected in step S300 in accordance with the display priority in step S306 or S308. When step S310 is completed, the process performed by the control device 50 proceeds to step S312.

Step S312: The control device 50 determines whether there is a next object. If there is a next object (YES in step S312), the process performed by the control device 50 returns to step S302. If there is no next object (NO in step S312), the process performed by the control device 50 proceeds to step S314.

Step S314: The control device 50 determines whether there is a next region. If there is a next region (YES in step S314), the process performed by the control device 50 returns to step S300. If there is no next region (NO in step S314), the object control operation of the control device 50 ends.

In steps S300 to S314, when the owner attribute of the object matches the owner attribute of the region, the control device 50 increases the display priority of the object in the region to a display priority higher than that of when they do not match.

The display priority of an object determines whether an object is to be less prominent than another object. The control device 50 applies a first rule of displaying an object having a low display priority on the rear layer, for example. The control device 50 may apply a second rule of transparently displaying an object having a low display priority. The control device 50 may apply a third rule of displaying an object having a low display priority in a reduced-size or as an icon. The control device 50 may apply a fourth rule of not displaying an object having a low display priority. The control device 50 may apply the first, second, or third rule only when an object having a high display priority overlaps with an object having a low display priority. When an object having a low display priority is displayed across regions, that is, when the object crosses the border of a region, the control device 50 may apply the first, second, or third rule to only the portion of the object crossing the border.

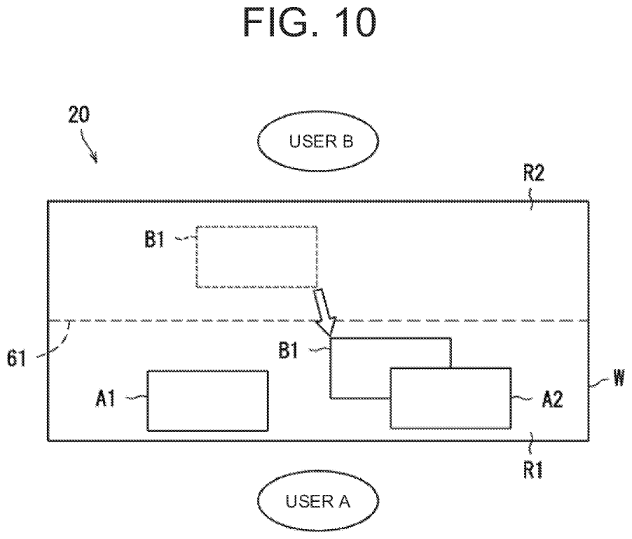

A display example of the display device 20 will now be described with reference to FIGS. 3 to 12. FIGS. 10 to 12 illustrate example displays in the work area W of the display device 20.

The work area W is shared by two users A and B, as illustrated in FIG. 10. The work area W is equally divided into regions R1 and R2 by a boundary line 61. Objects A1 and A2 are displayed in the region R1. An object B1 is displayed in the region R2.

The owner of the objects A1 and A2 is user A, and the owner of the object B1 is user B, as illustrated in FIG. 4. The owner of the region R1 is user A, and the owner of the region R2 is user B, as illustrated in FIG. 5. User A is the owner of a touch pen 30 having a pen ID of “001”, and user B is the owner of a touch pen 30 having a pen ID of “002”, as illustrated in FIG. 6.

The object owner of the objects A1 and A2 and the region owner of the region R1 are both user A. The object owner of the object B1 and the region owner of the region R2 are both user B. Thus, the display priority of the objects A1, A2, and B1 are all set to “high”, as in step S306 in FIG. 9.

User B moves the object B1 from the region R2 to the region R1 by a touch operation using a finger, as indicated by the arrow in FIG. 10. The owner of region R1 is user A, and the owner of object B1 is user B. The object owner of the object B1 does not match the region owner of the region R1. Thus, the display priority of the object B1 is set to “low”, as in step S308 in FIG. 9. As a result, for example, the object A2 is displayed on the front layer, and the object B1 is displayed on the rear layer, as in step S310 in FIG. 9. In other words, the display of the objects A1 and A2 owned by user A is prevented from being interfered by the object B1 owned by user B.

In the case where user A is to receive the object B1 and become its owner, user A touches the object B1 with the touch pen 30 owned by user A. As a result, the owner of the object B1 is changed from user B to user A, as in steps S104 and S106 in FIG. 7.

The operation to change the position of the boundary line 61 of the work area W will now be explained.

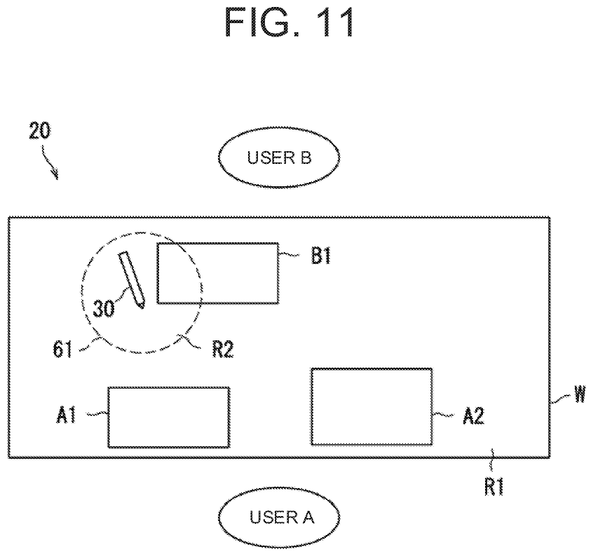

FIG. 11 illustrates the result of a touch operation performed outside of the object B1 by user B using a touch pen 30 owned by user B. The region R2 is provided to have a predetermined size contain the touch position of the touch pen 30, and the owner of the region R2 is thereby set to be user B, as in steps S200, S202, and S204 in FIG. 8. That is, the region inside of the closed boundary line 61 is defined to be the region R2 owned by user B. The region outside of the closed boundary line 61 is defined to be the region R1 owned by user A.

If an object owned by the owner of the region R2 resides in the region R2, as illustrated in FIG. 11, the region R2 may contain the object.

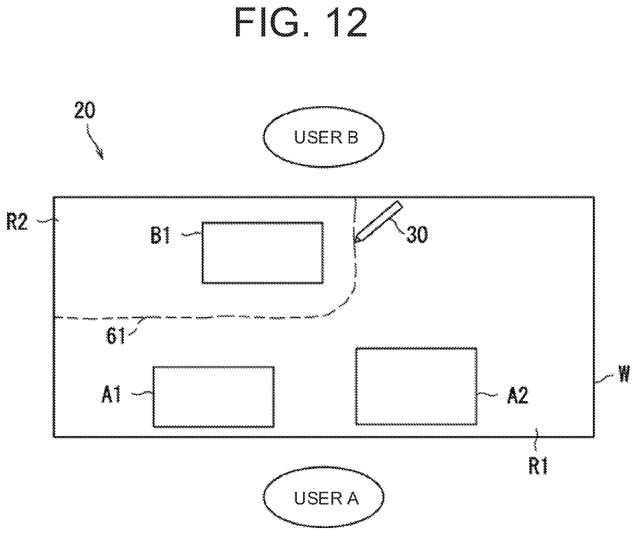

FIG. 12 illustrates the result of user B drawing a new boundary line 61 using the touch pen 30 owned by user B. The owner of the region R2 defined by the new boundary line 61 is set to be user B, as in steps S206 and S204 in FIG. 8. The owner of the region R1 or the remaining area of the work area W is set to be user A.

User A is able to change the position of the boundary line 61 through the same operation performed by user B.

The embodiments described above are preferred embodiments of the present invention. Thus, various technically preferable limitations may be imposed thereon. However, the technical scope of the present invention is not limited thereto, unless otherwise specified. That is, the components in the above embodiments are replaceable with known components as appropriate, and variations including combinations with other known components are possible. The description of the above embodiments does not limit the contents of the invention described in the claims.

1. In an embodiment, two users share the work area W, as illustrated in FIGS. 10 to 12. The present invention, however, is not limited thereto. The advantageous effects are achieved even when one user uses the work area W. For example, the display of an object based on a document file created by a user may be prevented from being interfered by another object based on a document file created by another user. The work area W may be shared by three or more users.

2. In an embodiment, the information processing apparatus 10 includes a pen-data receiver 35 in addition to the touch-data receiver 25, as illustrated in FIG. 3. The present invention, however, is not limited thereto. The pen-data receiver 35 may be omitted so long as the touch inputter 22 is capable of separately outputting a finger touch output and a pen touch output, and the touch-data receiver 25 is capable of receiving pen data from a touch pen 30.

The present invention is applicable to the field of information processing apparatuses.

### DESCRIPTION OF REFERENCE NUMERALS

10 information processing apparatus
20 display device
21 display
22 touch inputter
30 touch pen
50 control device
51 object manager (first manager)
52 region manager (second manager)
53 pen manager (third manager)
54 object controller (display controller)

What is claimed is:

1. An information processing apparatus comprising:
a display that displays an object;
a first manager that manages an owner attribute of the object; and
a display controller that controls a display priority of the object on the display based on the owner attribute of the object.

2. The information processing apparatus according to claim 1, further comprising:
a second manager that manages the owner attribute of a region constituting a portion of the display, wherein
the display controller controls the display priority of the object in the region based on the owner attribute of the object and the owner attribute of the region.

3. The information processing apparatus according to claim 2, wherein when the owner attribute of the object matches the owner attribute of the region, the display controller increases the display priority of the object in the region to be higher than the display priority when the owner attribute of the object does not match the owner attribute of the region.

4. The information processing apparatus according to claim 1, wherein the first manager sets, in the object, the owner attribute indicating a user who has created the object.

5. The information processing apparatus according to claim 1, wherein the display includes a touch panel, and the information processing apparatus further comprises a third manager that manages the owner attribute of a pen that touches the touch panel.

6. The information processing apparatus according to claim 5, wherein the first manager changes the owner attribute of the object so that the object has the same owner attribute as the owner attribute of the pen touching the object.

7. The information processing apparatus according to claim 5, wherein the second manager sets an owner attribute that is the same as the owner attribute of the pen to a region having a predetermined size and containing a position of the display touched by the pen.

8. The information processing apparatus according to claim 5, wherein the second manager sets an owner attribute that is the same as the owner attribute of the pen to the region defined by the pen on the display.

9. The information processing apparatus according to claim 1, wherein the display is shared by a plurality of users.
